(19) United States
(12) Patent Application Publication
(10) Pub. No.: US 2012/0109538 A1
(43) Pub. Date: May 3, 2012

(54) SYSTEM AND METHOD FOR DETERMINING, UPDATING, AND CORRECTING KINEMATIC STATE INFORMATION OF A TARGET

(75) Inventors: James A. Covello, Tucson, AZ (US); Tormod Fretheim, Oro Valley, AZ (US)

(73) Assignee: Raytheon Company, Waltham, MA (US)

(21) Appl. No.: 12/914,756

(22) Filed: Oct. 28, 2010

(51) Int. Cl. G06F 19/00; F42B 15/00

(52) U.S. Cl. 702/33; 244/3.1

(57) ABSTRACT

A process to preserve the kinematic state of a target includes determining an initial kinematic state estimate of the target using an observer with an active sensor. The initial kinematic state estimate includes a range from the observer to the target, a velocity of the target, and an acceleration of the target. The process further includes constructing an Extended Kalman Filter using the initial kinematic state estimate. The Extended Kalman filter is constructed by updating the initial kinematic state estimate as a function of time, receiving an angles-only measurement into the observer, calculating a new kinematic state as a function of the angles-only measurement, comparing the initial kinematic state estimate with the new kinematic state, constraining a rate of the target, and correcting the initial kinematic state estimate as a function of the comparison of the initial kinematic state estimate with the new kinematic state. The target is permitted to maneuver, and the observer is not required to maneuver.

### GOVERNMENT INTEREST CLAUSE

This invention was made with United States Government support under Contract Number WITHHELD with WITHHELD. The United States Government has certain rights in this invention.

### TECHNICAL FIELD

The present disclosure relates to a system and method for preserving target state information, and in an embodiment, but not by way of limitation, determining, updating, and correcting kinematic state information of a target.

### BACKGROUND

The state of the art of target state estimation offers little of use to passively guided air-to-air (or surface-to-air) missiles, despite the fact that knowledge of target range and range rate are very useful quantities for a missile. The state of the art is overwhelmingly dominated by the problems of tracking moving targets with active sensors—typically radar—which is of little help. Of the relatively small portion of the art that relates to passive sensors, some of it applies only to multiple observers (which is not much help for a missile that has to work alone), some of it applies only to a single observer that weaves back and forth across the sky in a frantic effort to emulate multiple observers (a tactic that will leave a missile with knowledge of where the target is but insufficient energy to reach it), and most of the rest of the art depends on the target not maneuvering (and frequently does not work even then). Some other approaches in the art combine angle information with other measurements, such as doppler or intensity, but have limited applicability.

Additionally, almost all of the art focuses on surveillance and fire control systems, which differ from guided missiles in two very important ways. First, a missile needs to intercept its target and, second, its efforts to do so invariably eliminate the observability required by any of the art's so-called bearings-only ranging methods. The bearings-only ranging method, and the passive ranging method, attempt to estimate target states (range and range rate) from scratch. However, such estimates are possible and reliable only under relatively narrow conditions that the observer cannot assess and are usually not fulfilled in a missile application. Specifically, these methods diverge from the target's true states, even if they were correctly estimated originally (i.e., even if they originally converged), unless the observer maneuvers continuously, which cannot be fulfilled by a missile. Consequently, these methods are confounded by any target maneuver. The elimination of the observability is a direct consequence of proportional navigation, which strives to eliminate all line of sight rate to the target. There are alternatives to proportional navigation, but since any efficient guidance law fundamentally strives to minimize ownship or observer maneuvers, the problem is unavoidable in most cases.

As noted above, the bearings-only ranging and passive ranging methods diverge from a target's true state, even if they originally converged. However, convergence can be a problem also, especially when using a Kalman Filter or an Extended Kalman Filter. Convergence is a very non-linear problem for moving/maneuvering targets, and Extended Kalman Filters all depend on linearization. If the assumed operating point is in error, the filter will converge to very poor estimates, and there is no established method for determining whether estimates are good. Divergence is of equal concern, for even when a filter is properly converged, periods of low observability frequently result in filter divergence, and like with convergence, there are no established methods for determining whether the estimates are good.

The art is therefore in need of a manner to accurately and passively maintain the kinematic state information of a target.

### BRIEF DESCRIPTION OF THE DRAWINGS

FIG. 1 is a block diagram of an Extended Kalman Filter for use in connection with determining, updating, and correcting the kinematic state of a target.

FIG. 2 is another block diagram of an Extended Kalman Filter for use in connection with determining, updating, and correcting the kinematic state of a target.

FIGS. 3A and 3B are a flow chart of an example embodiment of a process to determine, update, and correct the kinematic state of a target.

FIG. 4 is a block diagram of a computer processor system in connection with which one or more embodiments of the present disclosure can operate.

### DETAILED DESCRIPTION

A system and method of preserving target kinematic state information with angles-only measurements is disclosed herein. Angles-only measurements typically involve the use of a video sensing device and algorithms that perform calculations using the position of the target in the field of view of the video sensing device. Knowledge of the full kinematic state of a target is a benefit in many applications, but it is difficult to reliably achieve with a single passive sensor alone. In an embodiment, in applications where a handover exists from an active sensor system to a passive system, a Kalman filter can be constructed that begins with initial state estimates provided by the active system, and applies angles-only measurements thereafter to preserve the kinematic state of the target. In an embodiment, the passive state estimation is restricted to a full state handover. In general, an active sensor system is one that includes a transmitter and that receives information back from the transmission. An example of an active sensor system uses radar. In general, a passive system is one that simply observes, such as a video sensor. The system and method of this disclosure can preserve the kinematic state information even in the presence of target maneuvers, and even in the absence of ownship or observer maneuvers. In situations where the observability is poor, pseudomeasurements that reflect additional knowledge of the expected target behavior—such as constant speed—can be applied. This constant speed assumption is particularly applicable to air breathing targets such as jet engines, which intake air and expel it at a high velocity to produce thrust, and which tend to travel at a constant speed.

In this disclosure, the following nomenclature is used.

Xₖ=target state vector (position, velocity, acceleration)

Pₖ=covariance matrix

R^{MP}=position of target relative to a missile (or other observer)

V^{T}=velocity of target

A^{T}=acceleration of target

Φₖ=state propagation matrix

Δu=ownship motion from time k−1 to k as a 9 state vector

ΔR^{M}=ownship position from time k−1 to k

zₖ=measurement residuals

Hₖ=measurement matrix

r=speed constraint measurement noise

C=speed constraint measurement matrix

Δt=delta time from k−1 to k

q=target maneuver standard deviation

Qₖ=fully coupled (9×9) process noise matrix

Q₁=one dimensional (3×3) process noise matrix

K=Kalman gain

K^{C}=Kalman gain for speed constraint

As previously noted, passive estimation of target state is a difficult problem, and one rendered even more difficult when the observer is a missile guiding on a target. There are certain geometries—even very common ones—where there is so little observability in the problem that any bearings-only ranging scheme is doomed to fail. For a missile that must be guided to a successful intercept, any tracking information which might be helpful can be important. So it is worthwhile to estimate the target states whenever it can be reliably accomplished. However, nearly all of the angles-only approaches to estimating the target state either begin with no meaningful initial guess, or more commonly, such approaches have to supply their own. While this makes sense from the standpoint of surveillance and fire control systems, for which it is a primary task to determine this information from scratch, it only represents a subset of the scenarios which face an air-to-air or surface-to-air missile. In many, and perhaps even most cases, the launch aircraft's fire control radar has a high quality estimate of the target's position and velocity (which includes range and range rate). Indeed, this information is used by the pilot to determine that the target is within the weapon's range and can be successfully engaged. Additionally, this information is provided to the missile prior to launch. While certainly not the only situation that exists in air-to-air engagements, this “handover” from an active system represents a common and important special case that is worth exploiting. In other situations, a full state handover can be done with multiple passive sensors using triangulation.

Compared to the two extremes of active tracking on the one hand and passive (ranging and) tracking on the other, the case of passive tracking with full state handover as disclosed herein is somewhere in between the two in terms of difficulty. In a general case (i.e., without handover knowledge) and as previously noted, passive full state estimators suffer from two well-documented challenges—convergence to the correct state and avoiding subsequent divergence from the correct state. Success in attaining the first goal (converging within small errors) requires good observability early in the engagement, and success in the second (staying within small errors) requires good observability throughout the rest of the engagement. Whereas it is conceivable that the first condition will be met in some engagements, closed-loop guidance on the target guarantees that the second condition will never be. In the disclosed case of a full state handover, the first problem of convergence is conveniently dodged. The second problem of divergence however still needs to be addressed.

In an embodiment, filtering techniques such as an Extended Kalman Filter (EKF) can be applied to the divergence problem. However, while it is contended by some that these filtering techniques have superior convergence and/or divergence properties, the fact remains that any pure angles-only method will inevitably diverge from the true target state because the guidance loop will drive the observability out of the system. This is the case even when using a full state handover, unless the duration of the engagement between a missile and a target is rather short.

Since a missile is required to guide to a target, and this fact alone guarantees that an angles-only approach will fail, an embodiment makes some assumptions that restrict the target's behavior. While it could be assumed that a target is non-maneuvering (and this may be appropriate in situations where the target is deemed to be unaware)—this represents an aggressive assumption, and one that when combined with a full state handover could be better termed a target state propagator than a target state estimator. A much less restrictive, but still useful, alternative is that it is assumed that the target maintains a constant speed. This assumption is useful because the ability of any aircraft to change heading far exceeds its ability (or inclination) to change speed. This is true even for high-performance fighters.

Consequently, in this disclosure, a somewhat conventional EKF is combined with a constant speed constraint. The constant speed constraint provides the extra, albeit assumed, information required to avoid most divergence problems, even when confronted with target maneuvers.

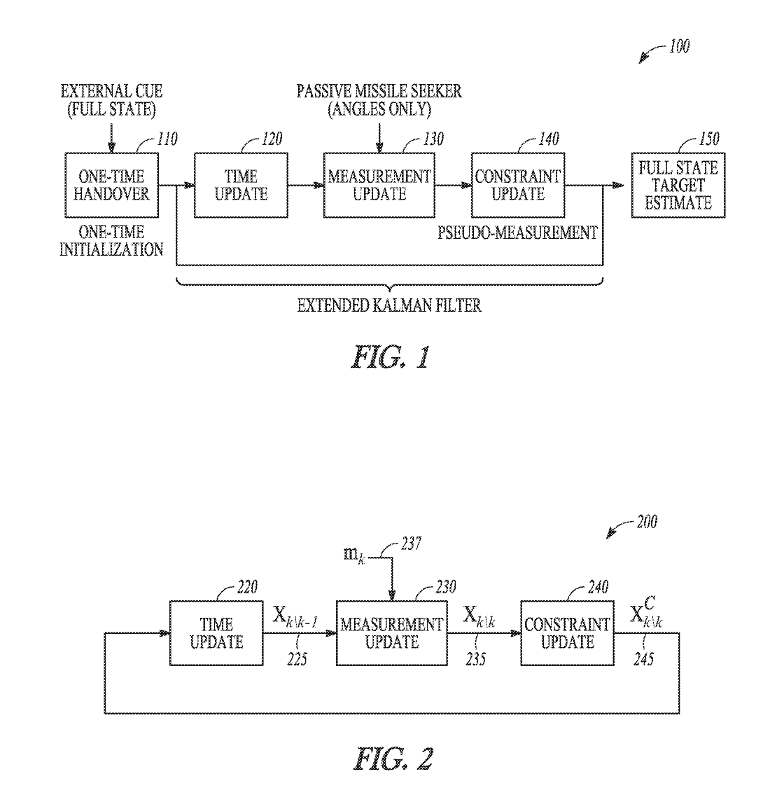

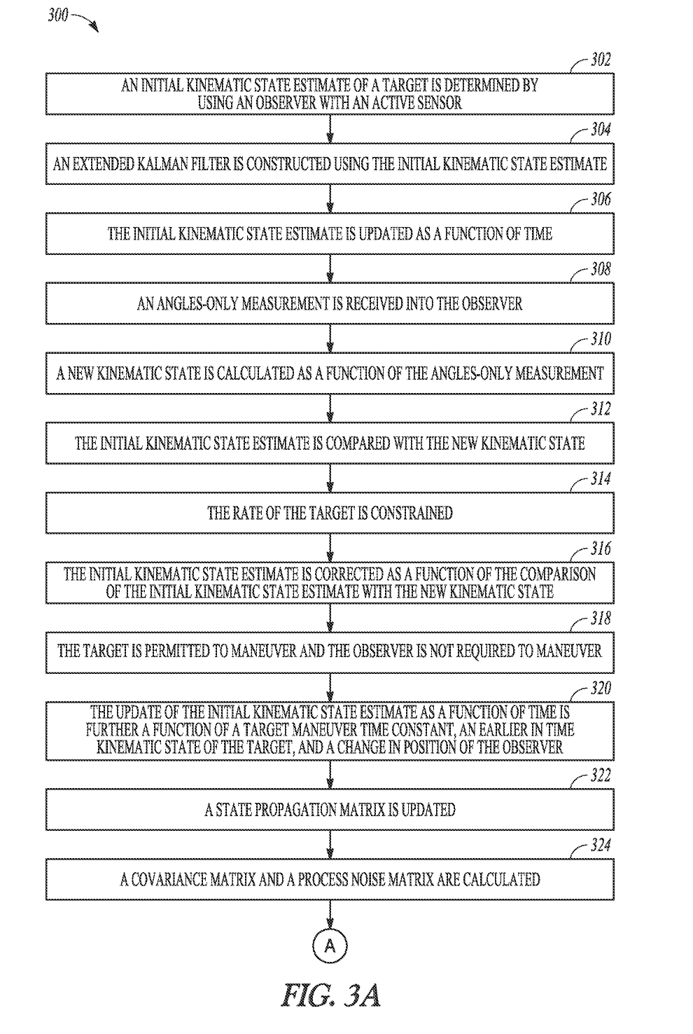

FIGS. 1 and 2 are block diagrams illustrating embodiments of Extended Kalman Filters 100 and 200 that are configured to preserve a kinematic state of a target. FIGS. 1 and 2 illustrate steps of a time update 120, 220, a measurement update 130, 230, and a constraint update 140, 240. The details of these steps will be discussed shortly herein. FIG. 1 further illustrates the full state handover 110 from an active sensor, and the resulting full state target estimate 150. FIG. 2 further illustrates the target kinematic vector x (225, 235) at times k and k−1, an angles-only measurement (237) mₖ, and the target kinematic vector 245 that is subjected to the constraint.

Although this disclosure refers in generic terms to “angles-only” measurements, it is preferable to formulate the filter in a pure-Cartesian manner. The Cartesian approach is both trigonometry- and singularity-free, neither of which is true of formulations that use angles (such as azimuth and elevation) directly. A nine state filter is generated. The state vector is defined as

$$x = ( \begin{matrix}{R}^{MT} \\ {V}^{T} \\ {A}^{T}\end{matrix} ) , \qquad ( 1 )$$

wherein the vector R^{MT} is the position of the target relative to the missile, V^{T} is the (absolute) target velocity, and A^{T} is the (absolute) target acceleration.

The filter time update equations to the current time, tₖ, are quite standard, and are as follows:

X_{k|k-1}=Φₖ₋₁xₖ₋₁−Δuₖ and

$$Δ {u}_{k} = ( \begin{matrix}Δ {R}_{k}^{M} \\ {0}_{6 \times 1}\end{matrix} ) \qquad ( 3 )$$

where Δuₖ is the change in ownship or observer missile position from time tₖ₋₁ to tₖ. This term is required because the state vector uses the position of the target relative to the missile rather than the target's absolute position. The covariance update is given by

P_{k|k-1}=Φₖ₋₁Pₖ₋₁Φ′ₖ₋₁+Qₖ₋₁. (4)

One advantage of adopting a Cartesian approach is that any of the standard sets of equations typically developed for radar applications can be used. For example, an embodiment can use the state transition matrix

$${Φ}_{k - 1} ( \begin{matrix}1 & 0 & 0 & Δ t & 0 & 0 & τ [ Δ t - τ ( 1 - ρ ) ] & 0 & 0 \\ 0 & 1 & 0 & 0 & Δ t & 0 & 0 & τ [ Δ t - τ ( 1 - ρ ) ] & 0 \\ 0 & 0 & 1 & 0 & 0 & Δ t & 0 & 0 & τ [ Δ t - τ ( 1 - ρ ) ] \\ 0 & 0 & 0 & 1 & 0 & 0 & τ ( 1 - ρ ) & 0 & 0 \\ 0 & 0 & 0 & 0 & 1 & 0 & 0 & τ ( 1 - ρ ) & 0 \\ 0 & 0 & 0 & 0 & 0 & 1 & 0 & 0 & τ ( 1 - ρ ) \\ 0 & 0 & 0 & 0 & 0 & 0 & ρ & 0 & 0 \\ 0 & 0 & 0 & 0 & 0 & 0 & 0 & ρ & 0 \\ 0 & 0 & 0 & 0 & 0 & 0 & 0 & 0 & ρ\end{matrix} ) , \qquad ( 5 )$$

wherein the sample period Δt=tₖ₊₁−tₖ, τ is the target maneuver time constant, and ρ=exp(−t/τ). In general, the target maneuver time constant is smaller for highly maneuverable targets (such as a fighter jet) and larger for less maneuverable targets (such as a large airliner).

In a one-dimensional problem where the sample period is much smaller than the target maneuver time constant (i.e., Δt<<τ), the process noise matrix can be approximated as

$${Q}_{1} = \frac{2 {q}^{2}}{τ} ( \begin{matrix}\frac{1}{20} Δ {t}^{5} & \frac{1}{8} Δ {t}^{4} & \frac{1}{6} Δ {t}^{3} \\ \frac{1}{8} Δ {t}^{4} & \frac{1}{3} Δ {t}^{3} & \frac{1}{2} Δ {t}^{2} \\ \frac{1}{6} Δ {t}^{3} & \frac{1}{2} Δ {t}^{2} & Δ t\end{matrix} ) , \qquad ( 6 )$$

wherein q is the target maneuver standard deviation. Based on how the target states within the state vector, x, have been ordered, the process noise matrix, when extended to three dimensions, becomes

$$Q = \frac{2}{τ} ( \begin{matrix}{q}_{x}^{2} \frac{Δ {t}^{5}}{20} & 0 & 0 & {q}_{x}^{2} \frac{Δ {t}^{4}}{8} & 0 & 0 & {q}_{x}^{2} \frac{Δ {t}^{3}}{6} & 0 & 0 \\ 0 & {q}_{y}^{2} \frac{Δ {t}^{5}}{20} & 0 & 0 & {q}_{y}^{2} \frac{Δ {t}^{4}}{8} & 0 & 0 & {q}_{y}^{2} \frac{Δ {t}^{3}}{6} & 0 \\ 0 & 0 & {q}_{z}^{2} \frac{Δ {t}^{5}}{20} & 0 & 0 & {q}_{z}^{2} \frac{Δ {t}^{4}}{8} & 0 & 0 & {q}_{z}^{2} \frac{Δ {t}^{3}}{6} \\ {q}_{x}^{2} \frac{Δ {t}^{4}}{8} & 0 & 0 & {q}_{x}^{2} \frac{Δ {t}^{3}}{3} & 0 & 0 & {q}_{x}^{2} \frac{Δ {t}^{2}}{2} & 0 & 0 \\ 0 & {q}_{y}^{2} \frac{Δ {t}^{4}}{8} & 0 & 0 & {q}_{y}^{2} \frac{Δ {t}^{3}}{3} & 0 & 0 & {q}_{y}^{2} \frac{Δ {t}^{2}}{2} & 0 \\ 0 & 0 & {q}_{z}^{2} \frac{Δ {t}^{4}}{8} & 0 & 0 & {q}_{z}^{2} \frac{Δ {t}^{3}}{3} & 0 & 0 & {q}_{z}^{2} \frac{Δ {t}^{2}}{2} \\ {q}_{x}^{2} \frac{Δ {t}^{3}}{6} & 0 & 0 & {q}_{x}^{2} \frac{Δ {t}^{2}}{2} & 0 & 0 & {q}_{x}^{2} Δ t & 0 & 0 \\ 0 & {q}_{y}^{2} \frac{Δ {t}^{3}}{6} & 0 & 0 & {q}_{y}^{2} \frac{Δ {t}^{2}}{2} & 0 & 0 & {q}_{y}^{2} Δ t & 0 \\ 0 & 0 & {q}_{z}^{2} \frac{Δ {t}^{3}}{6} & 0 & 0 & {q}_{z}^{2} \frac{Δ {t}^{2}}{2} & 0 & 0 & {q}_{z}^{2} Δ t\end{matrix} ) \qquad ( 7 )$$

If desired, the filter can be made to prefer level flight by using a smaller value for q_{z} than for qₓ and q_{y}.

The measurement update equations follow the standard form for Kalman filters:

x_{k|k}=x_{k|k-1}+KₖZₖ, (8)

P_{k|k}=[I−KₖHₖ]P_{k|k-1}, and (9)

Kₖ=P_{k|k}H′ₖ[HₖP_{k|k-1}H′ₖ+Rₖ]⁻¹. (10)

The measurement matrix, Hₖ. represents the linearized relationship between the “angle” measurements (i.e., the line of sight unit vector) and the position of the target. Rₖ is a sensor uncertainty factor. Rₖ is based on sensor measurement statistics and can be determined from hardware test data.

$${H}_{k} = [ \begin{matrix}\frac{{s}_{2 , k}^{′}}{‖ {R}_{k \vert k - 1}^{MT} ‖} & {0}_{1 \times 6} \\ \frac{{s}_{3 , k}^{′}}{‖ {R}_{k \vert k - 1}^{MT} ‖} & {0}_{1 \times 6}\end{matrix} ] \qquad ( 11 )$$

wherein s_{2,k} and s_{3,k} are arbitrarily chosen unit vectors that are mutually orthogonal to each other and the expected line of sight to the target, s_{1,k}. which in turn is given by

$${s}_{1 , k} = \frac{{R}_{k \vert k - 1}^{MT}}{‖ {R}_{k \vert k - 1}^{MT} ‖} . \qquad ( 12 )$$

The measurement residuals, zₖ, are formed from the measurement line of sight unit vector, mₖ, as follows:

$${z}_{k} = [ \begin{matrix}( {m}_{k} - {s}_{1 , k} ) \cdot {s}_{2 , k} \\ ( {m}_{k} - {s}_{1 , k} ) \cdot {s}_{3 , k}\end{matrix} ] \qquad ( 13 )$$

Enforcing the constant speed constraint on the target is accomplished by performing a speed constraint update using the following equations:

x_{k|k}^{C}=└I−Kₖ^{C}Cₖ┘x_{k|k}, (14)

P_{k|k}^{C}=└I−Kₖ^{C}Cₖ┘P_{k|k}, (15)

K_{k|k}^{C}=P_{k|k}C′ₖ[CₖP_{k|k}C′ₖ+r]⁻¹, and (16)

$${C}_{k} = \frac{1}{\sqrt{{\dot{x}}_{k \vert k}^{2} + {\dot{y}}_{k \vert k}^{2} + {\dot{z}}_{k \vert k}^{2}}} [ \begin{matrix}{0}_{1 \times 6} & {\dot{x}}_{k \vert k} & {\dot{y}}_{k \vert k} & {\dot{z}}_{k \vert k}\end{matrix} ] . \qquad ( 17 )$$

These equations enforce the orthogonality between the target's velocity and acceleration vectors that is required to maintain a constant speed. This is mathematically expressed as

V·A=0. (18)

While equations (14-17) do not implement a hard constraint on the target's estimated speed, they do serve to keep the estimator away from solutions that have the target's speed continually (and often rapidly) increasing or decreasing. The end result is that the target state estimates are much more consistent with how an aircraft typically flies. The speed constraint “noise”, r, is chosen to be a constant rather than decaying to a steady state value. This exception is made because it is assumed that there are good initial state estimates from the handover by the active sensor, and there is no need to wait for the filter to converge. In an embodiment, r is a tunable parameter that controls how strongly the constant speed constraint is enforced.

It is noted that the kinematic approach of using a constant target speed has only been applied to active sensors. The system and method disclosed herein can be used on aircraft, unmanned air vehicles, cruise and other missiles, ships and submarines. The system and method can also be used for collision avoidance.

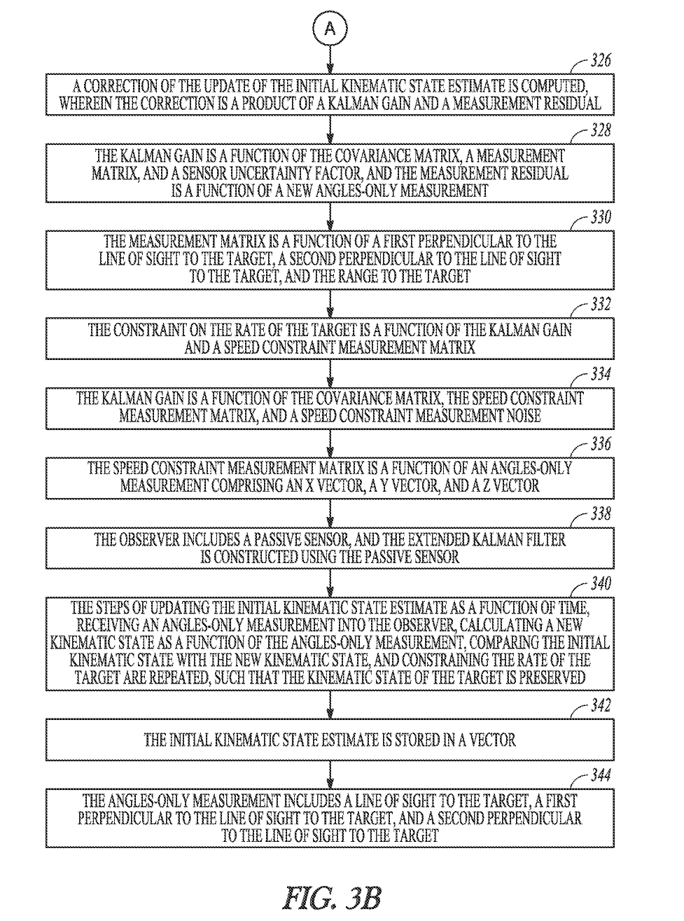

FIG. 3 is a flowchart of an example process 300 for determining, updating, and correcting an initial kinematic state estimate of a target. FIG. 3 includes a number of process blocks 305-344. Though arranged serially in the examples of FIG. 3, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations. In an embodiment, the process 300 of FIG. 3 is performed by a passively guided missile.

Referring specifically now to FIG. 3, at 302, an initial kinematic state estimate of a target is determined by using an observer with an active sensor. An observer can include such things as an aircraft or a ground station. The initial kinematic state estimate includes a range from the observer to the target, a velocity of the target, and an acceleration of the target. At 304, an Extended Kalman Filter is constructed using the initial kinematic state estimate. The construction of the Extended Kalman filter includes the several following steps. At 306, the initial kinematic state estimate is updated as a function of time. At 308, an angles-only measurement is received into the observer. At 310, a new kinematic state is calculated as a function of the angles-only measurement. At 312, the initial kinematic state estimate is compared with the new kinematic state. At 314, the rate of the target is constrained. At 316, the initial kinematic state estimate is corrected as a function of the comparison of the initial kinematic state estimate with the new kinematic state. At 318, the target is permitted to maneuver and the observer is not required to maneuver.

At 320, the update of the initial kinematic state estimate as a function of time is further a function of a target maneuver time constant, an earlier in time kinematic state of the target, and a change in position of the observer. At 322, a state propagation matrix is updated. At 324, a covariance matrix and a process noise matrix are calculated. At 326, a correction of the update of the initial kinematic state estimate is computed, wherein the correction is a product of a Kalman gain and a measurement residual. At 328, the Kalman gain is a function of the covariance matrix, a measurement matrix, and a sensor uncertainty factor, and the measurement residual is a function of a new angles-only measurement. At 330, the measurement matrix is a function of a first perpendicular to the line of sight to the target, a second perpendicular to the line of sight to the target, and the range to the target. At 332, the constraint on the rate of the target is a function of the Kalman gain and a speed constraint measurement matrix. At 334, the Kalman gain is a function of the covariance matrix, the speed constraint measurement matrix, and a speed constraint measurement noise. At 336, the speed constraint measurement matrix is a function of an angles-only measurement comprising an x vector, a y vector, and a z vector. At 338, the observer includes a passive sensor, and the Extended Kalman Filter is constructed using the passive sensor. At 340, the steps of updating the initial kinematic state estimate as a function of time, receiving an angles-only measurement into the observer, calculating a new kinematic state as a function of the angles-only measurement, comparing the initial kinematic state with the new kinematic state, and constraining the rate of the target are repeated, such that the kinematic state of the target is preserved.

At 342, the initial kinematic state estimate is stored in a vector. At 344, the angles-only measurement includes a line of sight to the target, a first perpendicular to the line of sight to the target, and a second perpendicular to the line of sight to the target.

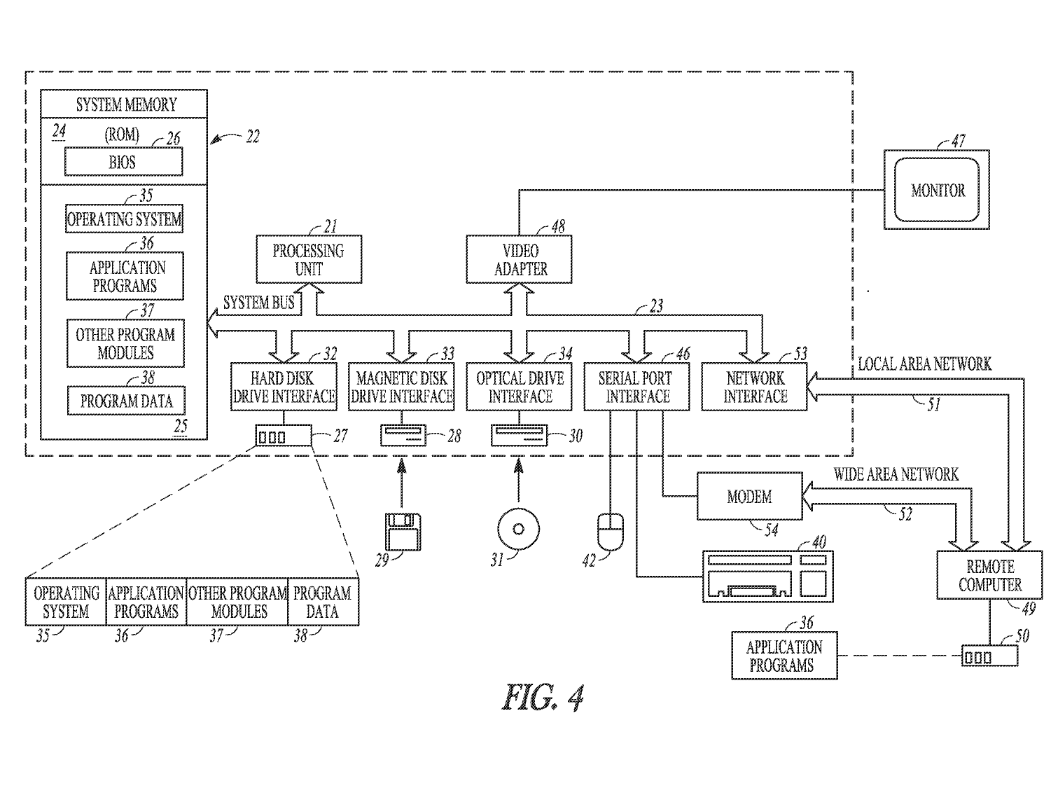

FIG. 4 is an overview diagram of a hardware and operating environment in conjunction with which embodiments of the invention may be practiced. The description of FIG. 4 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 4, a hardware and operating environment is provided that is applicable to any of the servers and/or remote clients shown in the other Figures.

As shown in FIG. 4, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 4 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

1. A process comprising:
determining an initial kinematic state estimate of a target using an observer with an active sensor, the initial kinematic state estimate comprising a range from the observer to the target, a velocity of the target, and an acceleration of the target; and
constructing an Extended Kalman Filter using the initial kinematic state estimate by:
updating the initial kinematic state estimate as a function of time;
receiving an angles-only measurement into the observer;
calculating a new kinematic state as a function of the angles-only measurement;
comparing the initial kinematic state estimate with the new kinematic state;
constraining a rate of the target; and
correcting the initial kinematic state estimate as a function of the comparison of the initial kinematic state estimate with the new kinematic state;
wherein the target is permitted to maneuver and the observer is not required to maneuver.

2. The process of claim 1, wherein the updating the initial kinematic state estimate as a function of time is further a function of a target maneuver time constant, an earlier in time kinematic state of the target, and a change in position of the observer.

3. The process of claim 2, comprising updating a state propagation matrix.

4. The process of claim 3, comprising calculating a covariance matrix and a process noise matrix.

5. The process of claim 4, comprising computing a correction of the update of the initial kinematic state estimate, the correction comprising a product of a Kalman gain and a measurement residual.

6. The process of claim 5, wherein the Kalman gain is a function of the covariance matrix, a measurement matrix, and a sensor uncertainty factor; and the measurement residual is a function of a new angles-only measurement.

7. The process of claim 6, wherein the measurement matrix is a function of a first perpendicular to the line of sight to the target, a second perpendicular to the line of sight to the target, and the range to the target.

8. The process of claim 7, wherein the constraint on the rate of the target is a function of the Kalman gain and a speed constraint measurement matrix.

9. The process of claim 8, wherein the Kalman gain is a function of the covariance matrix, the speed constraint measurement matrix, and a speed constraint measurement noise.

10. The process of claim 8, wherein the speed constraint measurement matrix is a function of an angles-only measurement comprising a x vector, a y vector, and a z vector.

11. The process of claim 1, wherein the observer comprises a passive sensor, and the Extended Kalman Filter is constructed using the passive sensor.

12. The process of claim 1, comprising repeating the steps of updating the initial kinematic state estimate as a function of time, receiving an angles-only measurement into the observer, calculating a new kinematic state as a function of the angles-only measurement, comparing the initial kinematic state with the new kinematic state, and constraining the rate of the target, such that the kinematic state of the target is preserved.

13. The process of claim 1, wherein the initial kinematic state estimate is stored in a vector.

14. The process of claim 1, wherein the angles-only measurement comprises a line of sight to the target, a first perpendicular to the line of sight to the target, and a second perpendicular to the line of sight to the target.

15. A computer readable medium comprising instructions that when executed by a processor execute a process comprising:
determining an initial kinematic state estimate of a target using an observer with an active sensor, the initial kinematic state estimate comprising a range from the observer to the target, a velocity of the target, and an acceleration of the target; and
constructing an Extended Kalman Filter using the initial kinematic state estimate by:
updating the initial kinematic state estimate as a function of time;
receiving an angles-only measurement into the observer;
calculating a new kinematic state as a function of the angles-only measurement;
comparing the initial kinematic state estimate with the new kinematic state;
constraining a rate of the target; and
correcting the initial kinematic state estimate as a function of the comparison of the initial kinematic state estimate with the new kinematic state;
wherein the target is permitted to maneuver and the observer is not required to maneuver.

16. The computer readable medium of claim 15, wherein the observer comprises a passive sensor, and the Extended Kalman Filter is constructed using the passive sensor.

17. The computer readable medium of claim 15, comprising instructions for repeating the steps of updating the initial kinematic state estimate as a function of time, receiving an angles-only measurement into the observer, calculating a new kinematic state as a function of the angles-only measurement, comparing the initial kinematic state with the new kinematic state, and constraining the rate of the target, such that the kinematic state of the target is preserved.

18. The computer readable medium of claim 15, wherein the initial kinematic state estimate is stored in a vector.

19. The computer readable medium of claim 15, wherein the angles-only measurement comprises a line of sight to the target, a first perpendicular to the line of sight to the target, and a second perpendicular to the line of sight to the target

20. A guidance system comprising:
one or more computer processors configured for:
determining an initial kinematic state estimate of a target using an observer with an active sensor, the initial kinematic state estimate comprising a range from the observer to the target, a velocity of the target, and an acceleration of the target; and
constructing an Extended Kalman Filter using the initial kinematic state estimate by:
updating the initial kinematic state estimate as a function of time;
receiving an angles-only measurement into the observer;
calculating a new kinematic state as a function of the angles-only measurement;
comparing the initial kinematic state estimate with the new kinematic state;
constraining a rate of the target; and
correcting the initial kinematic state estimate as a function of the comparison of the initial kinematic state estimate with the new kinematic state;
wherein the target is permitted to maneuver and the observer is not required to maneuver.

21. The guidance system of claim 20, wherein the observer comprises a passive sensor, and the Extended Kalman Filter is constructed using the passive sensor.

22. The guidance system of claim 20, comprising a computer processor configured for repeating the steps of updating the initial kinematic state estimate as a function of time, receiving an angles-only measurement into the observer, calculating a new kinematic state as a function of the angles-only measurement, comparing the initial kinematic state with the new kinematic state, and constraining the rate of the target, such that the kinematic state of the target is preserved.

23. The guidance system of claim 20, wherein the initial kinematic state estimate is stored in a vector.

24. The guidance system of claim 20, wherein the angles-only measurement comprises a line of sight to the target, a first perpendicular to the line of sight to the target, and a second perpendicular to the line of sight to the target.

25. The guidance system of claim 20, wherein the guidance system is installed on a guided missile.
